(19) United States
(12) Patent Application Publication
(10) Pub. No.: US 2014/0255559 A1
(43) Pub. Date: Sep. 11, 2014

(54) Confection Piece Shape

(71) Applicant: MARS, INCORPORATED, Hackettstown, NJ (US)

(72) Inventors: Leigh Storah, London (GB); Gemma Cudjoe, Reading (GB); Bruce Hannant, Battersea (GB); Timothy Harold Moore, Dublin (IE); Carsten Astheimer, Warwickshire (GB)

(73) Assignee: MARS, INCORPORATED, Hackettstown, NJ (US)

(21) Appl. No.: 14/177,480

(22) Filed: Feb. 11, 2014

Related U.S. Application Data
(60) Provisional application No. 61/774,159, filed on Mar. 7, 2013.

(51) Int. Cl. A23G 3/54; A23G 3/50

(52) U.S. Cl. CPC A23G 3/545; A23G 3/50
USPC 426/103; 426/660

(57) ABSTRACT

A confection is provided having a single arcuate ridge extending substantially the entire length of the piece. Due to this unique feature, either alone or in combination with one or more other topographical features, the confection provides an enhanced sensory attribute as compared to a confection having the same composition and not having the arcuate ridge.

### FIELD

The present invention relates to a confection having a piece shape that provides an improved consuming experience.

### BACKGROUND

Confections are enjoyed by consumers for the pleasurable consuming experience they provide. The consuming experience, in turn, is multifaceted—defined not only by the taste of the confection, but also, by other attributes of the confection that may be perceived via touch or feeling in the mouth, as well as by visual, auditory, and/or olfactory attributes. For example, a combination of the feel of a confection in the hands, the sound it makes when broken or bitten into, its smell, and ability of the confection to be moved within the mouth can all contribute to the pleasure experienced when confections are consumed.

Manufacturers of confections are constantly striving to enhance the consuming experience provided by their products, and oftentimes do so via the provision of new formulations, flavor combinations, and/or new or enhanced packaging. While all of these can be effective, the capacity for enhanced enjoyment is perceived to be limitless and new or improved ways of enhancing the consuming experience associated with confections are always welcome.

### BRIEF DESCRIPTION

The present invention provides a confection having a piece shape that provides such an enhanced consuming experience. More particularly, a confection having the disclosed shape may provide one or more of an enhanced taste, touch or mouthfeel, visual, and/or auditory attributes as compared to a confection of the same composition, but of a different shape. Because the shape, and not the formulation, of the confection is altered relative to conventional confections, confectionary formulations that enjoy consumer acceptance or success need not be altered formulaically. Additional raw materials need not be sourced, approved or purchased, and raw material savings are thus provided. The confections are capable of being produced on commercially available equipment, so additional capital costs beyond perhaps the cost of a mold, need not be incurred.

In one aspect, a confection is provided. The confection comprises a single arcuate ridge, wherein the ridge extends substantially the entire length of a single piece of the confectionery. The ridge may typically define two regions of the confection, and the regions may be of approximately the same size, or may be different sizes. At least one region comprises a feature, and in some embodiments, both regions comprise a feature. In the case of the latter, the features may be the same, may be different, or may be complementary.

The features are provided on, or defined relative to, the surface of the confection, i.e., the features may be topographical. Suitable features include depressions, domes, flats, gaps, gorges, hills, hollows, knobs, knolls, peaks, pinnacles, pits, plateaus, points, rises, slopes, valleys, etc. In some embodiments, the features may comprise depressions, hollows, knobs, knolls, rises and/or slopes. In embodiments wherein the confection comprises two of the same feature, i.e., two depressions or hollow or two peaks, rises or slopes, two different features, such as one depression and one flat, or two complementary features, i.e., a depression and a rise.

The shape of the confection, comprising the single arcuate ridge, provides it with one sensory attribute that is enhanced, relative to a confection having the same composition and not comprising the arcuate ridge. The enhanced sensory attribute may be a visual, taste, texture and/or auditory attribute. Visual attributes that may be enhanced include expected comfort in mouth, smoothness, height/thickness, darkness, depth of any indentations, roundedness, or a combination of any number of these. Taste or texture attributes that may be enhanced include comfort in mouth, fit to palate, ease of movement in mouth, smoothness, speed of melt, adhesive, roundness, or a combination of any number of these. Auditory attributes that may be enhanced include snap, chomp, bite, and combinations thereof.

Any confection may be provided with the shape, and be expected to enjoy the benefits of the same. Suitable confections include individual piece confections or multi-piece sticks, bars or blocks, which can include multiple regions, fillings, inclusions, etc. and which can also include solid chocolate, filled chocolate, multi-region confection including chocolate, and compound coating versions of each of the aforementioned confections. In some embodiments, the confection may be a fat-based confection, and in some of these, may be cocoa-based. In some embodiments, the confection comprises chocolate. Similarly, the confection may be provided in any suitable format, i.e., the confection may be provided as a bar including multiple separable servings, or may be provided as single pieces.

In another aspect, a confection having a base, four sidewalls and a top is provided. The top of each individual piece of the confection comprises a single ridge extending the entire length of the individual piece.

### BRIEF DESCRIPTION OF THE DRAWINGS

FIG. 1A is a top view of a confection according to one embodiment;

FIG. 1B is a side view of the embodiment of the confection shown in FIG. 1A;

FIG. 2A is a perspective view of a confection according to one embodiment;

FIG. 2B is a top view of the embodiment of the confection shown in FIG. 2A;

FIG. 3 is a graphical representation of a monadic assessment of several visual attributes of one embodiment of the confection (42 g New, red line) as compared to a conventional confection (46 g Current, blue line);

FIG. 4 is a graphical representation of a monadic assessment of several visual attributes of another embodiment of the confection (114 g New, red line) as compared to a conventional confection (114 g Current, blue line);

FIG. 5 is a graphical representation of a monadic assessment of several mouthfeel attributes of one embodiment of the confection (42 g New, red line) as compared to a conventional confection (46 g Current, blue line);

FIG. 6 is a graphical representation of a monadic assessment of several mouthfeel attributes of another embodiment of the confection (114 g New, red line) as compared to a conventional confection (114 g Current, blue line); and

FIG. 7 is a graphical representation of a comparative assessment of several mouthfeel attributes of the same embodiment of the confection shown in FIG. 6 (114 g New, red line) as compared to a conventional confection (114 g Current, blue line).

### DETAILED DESCRIPTION

The present specification provides certain definitions and methods to better define the present invention and to guide those of ordinary skill in the art in the practice of the present invention. Provision, or lack of the provision, of a definition for a particular term or phrase is not meant to imply any particular importance, or lack thereof. Rather, and unless otherwise noted, terms are to be understood according to conventional usage by those of ordinary skill in the relevant art.

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

If ranges are disclosed, the endpoints of all ranges directed to the same component or property are inclusive and independently combinable (e.g., ranges of “up to 25 wt. %, or, more specifically, 5 wt. % to 20 wt. %,” is inclusive of the endpoints and all intermediate values of the ranges of “5 wt. % to 25 wt. %,” etc.).

Reference throughout the specification to “one embodiment” or “an embodiment” means that a particular feature, structure, or characteristic described in connection with an embodiment is included in at least one embodiment. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The present invention contemplates the possibility of omitting any components or steps listed herein. The present invention further contemplates the omission of any components or steps even though they are not expressly named as included or excluded from the invention.

The present invention provides a confection having a shape that provides an enhanced consuming experience. More particularly, the confection comprises a single arcuate ridge that extends substantially the entire length of a single piece of the confection. As used herein, the term “arcuate” means having the shape of an arc and the term “ridge” means a continuous, long, narrow upper section, or crest. And so, taken together the phrase, “arcuate ridge” means a long, narrow, curved crest. Surprisingly, provision of this feature, alone or in combination with one or more of the others described herein, may enhance one or more sensory attributes of the confection, without the need to alter the formulation of the confection.

The arc may be an arc of any curve, and desirably may be a parabolic arc. The arc may be concave, or convex, or if a combination or arcs is used, may be concave in parts and convex in others. Desirably, the entirety of the arc is generally convex when the confection is viewed from the side.

In those embodiments wherein the entirety of the arc is generally convex, the arc may have a single peak that may also typically define the highest point of the confection. The arcuate ridge may be symmetrical about a vertical axis through its peak, or asymmetrical, about this axis. In some embodiments, the arcuate ridge is asymmetrical about a vertical axis though its peak.

The arcuate ridge defines two regions of the confection. These two regions may be of approximately the same dimensions, or different dimensions, and/or comprise approximately the same weight percentage or different weight percentages of the confection piece as a whole.

One or both regions may comprise a feature that, along with the ridge, further enhances the sensory attribute enhanced by the ridge, or enhances an additional sensory attribute, or both. If more than one feature is provided, whether in one or both regions, the additional features may be the same, or different.

Any feature(s) may be used, and desirably will be one(s) that, in combination with the arcuate ridge, enhance at least one sensory attribute of the confection. The features are advantageously described relative to the surface of the confection, and so may generally be any topographical feature. Examples of topographical features thought to be capable of enhancing at least one sensory attribute of the confection having the single arcuate ridge include, but are not limited to, depressions, domes, flats, gaps, gorges, hills, hollows, knobs, knolls, peaks, pinnacles, pits, plateaus, points, rises, slopes, valleys, decorations or other indicia, etc. In some embodiments, the features may comprise decorations, indicia depressions, hollows, knobs, knolls, rises and/or slopes. In embodiments wherein the confection comprises two of the same feature, i.e., two depressions or hollow or two peaks, rises or slopes, two different features, such as one depression and one flat, or two complementary features, i.e., a depression and a rise.

In some embodiments, the features provided on opposite sides of the arcuate ridge may be of different heights, or, may have different heights within the feature. The overall shape of the piece in such embodiments will not approximate a dome, previously thought to provide enhanced comfort and movability within the mouth. Rather, it has now been surprisingly discovered that by providing the piece with some higher and less high areas, the confection piece is more easily moved around within the mouth, leading to enhanced consumer enjoyment of the confection.

Ease of movement around the mouth is but one attribute that may be enhanced by the provision of the arcuate ridge. Any sensory attribute may be enhanced, and those of ordinary skill in the art are familiar with those associated with, or utilized during, the enjoyment of confections. The enhanced sensory attribute may be a visual, taste, texture and/or auditory attribute. Visual attributes that may be enhanced include expected comfort in mouth, smoothness, height/thickness, darkness, depth of any indentations, roundedness, or a combination of any number of these. Taste or texture attributes that may be enhanced include comfort in mouth, fit to palate, ease of movement in mouth, smoothness, speed of melt, adhesive, roundness, or a combination of any number of these. Auditory attributes that may be enhanced include snap, chomp, bite, and combinations thereof.

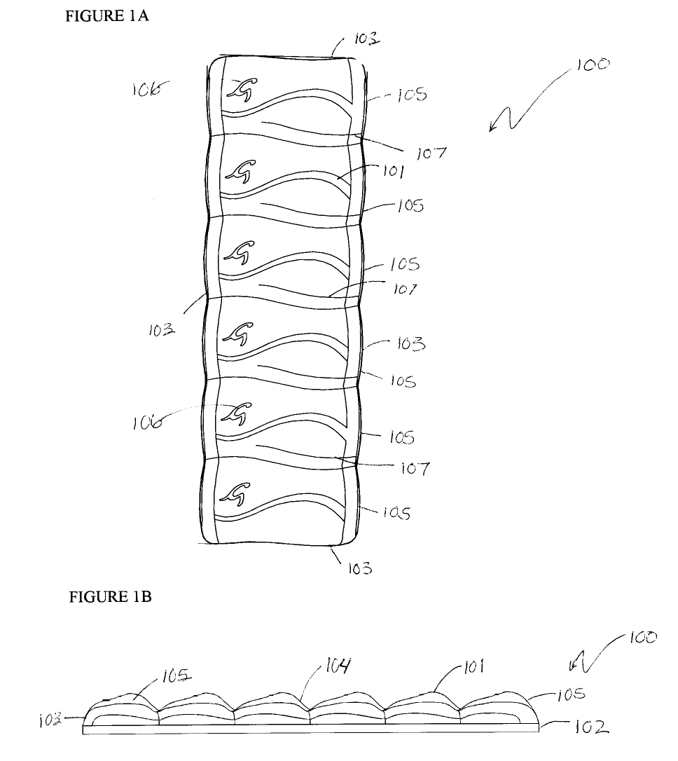

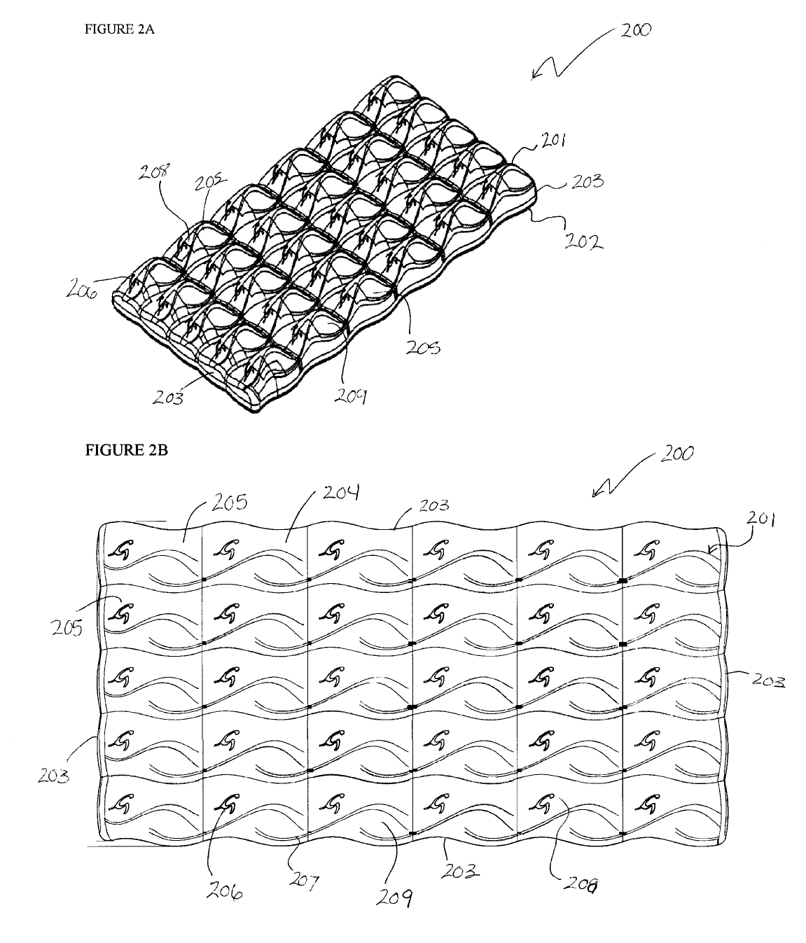

The confection may be provided in the form of a single serving, or in the form of a bar or block comprising a plurality of interconnected single serving pieces. One embodiment of such a confection, provided in two different formats, is shown in FIGS. 1A-2B. More particularly, in the embodiments shown in FIGS. 1A and 1B, the confection is provided in a 6 piece bar format, whereas in FIGS. 2A and 2B, the confection is provided in a multi-piece block format. As can be seen in each of these figures, in each embodiment, a single arcuate ridge (101 or 201, respectively) extends for substantially the entire length of each piece (105, 205). As best seen in FIG. 1B, the peak of the single arcuate ridge 101 defines the highest point of the confection piece. A feature comprising an indicia (106, 206) is visible in FIGS. 1A, 2A and 2B, whereas FIG. 2A provides perhaps the best view for appreciation of the provision of a recess or depression (209) on one side of the arcuate ridge (201) and a slope, dome or rise (208) on the opposite side of the arcuate ridge.

More specifically, with reference to FIGS. 1A and 1B, confection 100 includes comprises base 102, sides 103 (Four being visible in the top view of confection 100 shown in FIG. 1B and two being shown in the side view of confection 100 shown in FIG. 1A) and top 104. The embodiment of confection 100 shown is in the format of a bar comprising six individual pieces 105. Top 104 of each individual piece 105 comprises a single arcuate ridge 101 extending substantially the entire length of individual piece(s) 105. Top 104 of each individual piece 205 also bears the additional feature indicia 106 and secondary ridge 107. As can be seen, secondary ridge 107 does not extend for substantially the entire length of each individual piece 105, but rather, for only a portion of the length of each individual piece 105.

Confection 200, shown in FIGS. 2A and 2B, also comprises a base, a top and four sides. More particularly, as shown in FIGS. 2A and 2B, confection 200 comprises base 202, sides 203 (Two being shown in the perspective view of confection 200 shown in FIG. 2A and four being visible in the top view of confection 200 shown in FIG. 2B) and top 204. The embodiment of confection 200 shown is in the format of a block comprising multiple individual pieces 205. Top 204 of each individual piece 205 comprises a single arcuate ridge 201 extending substantially the entire length of individual piece(s) 205. Top 204 of each individual piece 205 also bears additional features, specifically, indicia 206 and secondary ridge 207. As can be seen, secondary ridge 207 does not extend for substantially the entire length of each individual piece 205, but rather, for only a portion of the length of each individual piece 205. Top 204 of each individual piece 205 further bears dome 208 and depression 209, which may be best appreciated by the perspective view provided in FIG. 2A.

Any confection may be provided with the shape, and be expected to enjoy the benefits of the same. Suitable confections include individual piece confections or multi-piece sticks, bars or blocks which can include multiple regions, fillings, inclusions, etc. and which can also include solid chocolate, filled chocolate, multi-region confection including chocolate, and compound coating versions of each of the aforementioned confections. Chocolates, caramels, taffy, toffee, and combinations thereof may be used. In some embodiments, the confection may be a fat-based confection, and in some of these, may be cocoa-based. In some embodiments, the confection comprises chocolate.

As used herein, the term “chocolate” refers to all chocolate or chocolate-like compositions with a fat phase or fat-like composition such that the composition can be processed according to the methods and with the apparatus described herein. The term refers, for example, to chocolates with compositions that conform to the U.S. Standards Of Identity (“SOI chocolate”), and compositions that do not conform to the U.S. Standards Of Identity (“non-SOI chocolate”). The standards of identity for different kinds of chocolate are found in Title 21, Part 163 of the Code of Federal Regulations, herein incorporated by reference. “Pure SOI chocolate,” as that term is used herein, is chocolate that meets the Standards Of Identity for chocolate, and that is further substantially free of corn syrups or other carbohydrate syrups used as an extender. Non-SOI chocolates include those in which at least one of the standard ingredients of chocolate (i.e., one or more of the nutritive carbohydrate sweetener, the cocoa butter, and the milk fat) are replaced partially or completely, those in which components that have flavors that imitate milk, butter, or chocolate are added, and those in which other additions or deletions in the formulation are made that are outside FDA standards of identity of chocolate.

As used herein, the term “chocolate” includes dark chocolate, baking chocolate, milk chocolate, sweet chocolate, semi-sweet chocolate, buttermilk chocolate, skim milk chocolate, mixed dairy product chocolate, low fat chocolate, white chocolate, aerated chocolates, compound coatings, and chocolate-like compositions, unless specifically identified otherwise. “Chocolate” also includes crumb solids or solids fully or partially made by a crumb process.

Because the shape, and not the formulation, of the confection is altered relative to conventional confections, confectionary formulations that enjoy consumer acceptance or success need not be altered formulaically. Additional raw materials need not be sourced, approved or purchased, and raw material savings are thus provided. The shapes are capable of being produced on commercially available equipment, and perhaps even equipment already owned by most confectionery manufacturers and so additional capital costs need not be incurred. Indeed, the confections may be produced by any of any known molding or forming technique, including those disclosed, e.g., by US Patent Application Publication No. 2011/0318475 and U.S. Patent Application Ser. No. 61/750,374, both of which are hereby incorporated herein in their entirety for any and all purposes.

### Example 1

A confection according to one embodiment is prepared by melting GALAXY® Brand Milk Chocolate and molding the melted chocolate to provide a bar (42 g) or block (114 g). Each individual piece of the bar or block has at least the single arcuate ridge extending substantially the entirety of its length. The comparative bar (46 g) or block (114 g) used in the testing have at least two ridges that extend substantially the entire length of each individual piece.

Each of 20 assessors were separately presented with the inventive and comparative bar or block, 50% testing the control first and the inventive confection second and 50% testing the inventive confection first and the control confection second.

Visual and mouthfeel assessments were made for each sample. The visual attribute testing was conducted under white light, while the mouthfeel assessment was conducted under red light to reduce any visual bias/obscure certain visual aspects of the sample. The visual attributes rated included “comfortable in mouth”, “smooth”, “height of bar”, “dark”, “depth of indentation” and “rounded”, whereas the mouthfeel attributes rated included “comfortable in mouth”, “fit to palate”, “ease to move around in the mouth”, “smooth”, “speed of melt”, “adhesive” and “rounded”.

Monadic profiling was conducted for each assessment. For monadic testing, samples are evaluated individually using the Sensory Spectrum Descriptive Analysis Method and quantified on a 0-15 “world of food” intensity scale. (The Sensory Spectrum Descriptive Analysis Method is described in detail in the following reference book: Sensory Evaluation Techniques, 3rd Edition, Morten Meilgaard, D. Sc., Gail Vance Civille, B. S. & B. Thomas Carr, M. S., CRC Press LLC, Boca Raton, Fla., 1999.)

Comparative profiling of the mouthfeel attributes of the block samples was also conducted. For comparative testing, each attribute was scored comparatively, i.e., the participants were asked whether they liked the inventive piece more or less than the comparative piece. More particularly, in the comparative testing, the participants were asked to rate each attribute on a comparative scale, i.e., to score each attribute as being much less, clearly less, slightly less, same as declared reference, slightly more, clearly more and much more present in the inventive sample relative to the comparative sample.

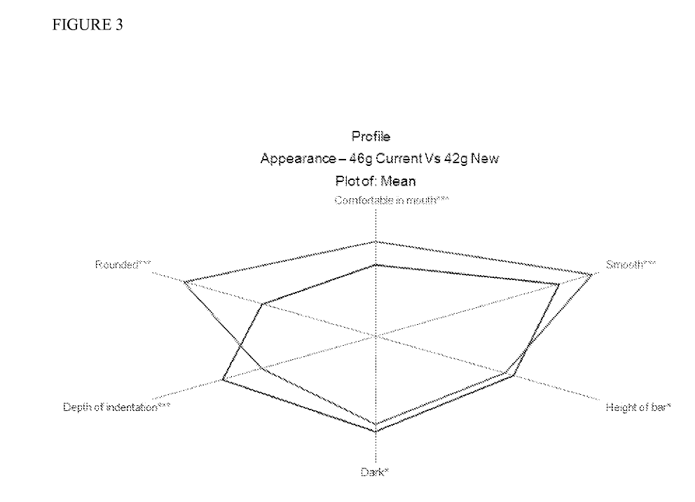

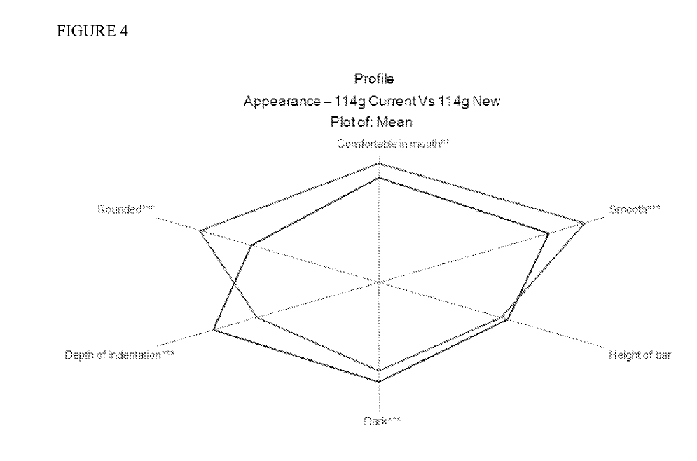

The results of the visual attribute testing are shown in Tables 1 and 2, below and FIGS. 3 and 4. In each of Tables 1-3, the A's and B's are indicators of statistical significance, i.e., where the letters are different the difference between the inventive and comparative measurement is statistically significant.

TABLE 1
Visual Attribute Testing - Bar Samples

| | Sample | | |
|---|---|---|---|
| | Inventive | Comparative | |
| Attribute | (42 g New) | (46 g Current) | Significance (α) |
| Comfortable in mouth | 7.48 A | 5.64 B | <0.0001*** |
| Smooth | 9.69 A | 8.22 B | 0.0005*** |
| Height of Bar | 5.82 B | 6.19 A | 0.0488* |
| Dark | 6.98 B | 7.56 A | 0.0116* |
| Depth of indentation | 5.10 B | 6.85 A | <0.0001*** |
| Rounded | 8.56 A | 5.07 B | <0.0001*** |

*Attribute significant at the 95% confidence limit
**Attribute significant at the 99% confidence limit
***Attribute significant at the 99.9% confidence limit

As shown in Table 1 and FIG. 3, the inventive confection has 3 visual attributes that are enhanced relative to the comparative confection. That is, the inventive confection looks significantly more rounded, smooth and has an appearance that led the assessors to conclude that it would be more comfortable in the mouth than the comparative confection.

TABLE 2
Visual Attribute Testing - Block Samples

| | Sample | | |
|---|---|---|---|
| | Inventive | Comparative | |
| Attribute | (114 g New) | (114 g Current) | Significance (α) |
| Comfortable in mouth | 9.23 A | 8.11 B | 0.0065** |
| Smooth | 9.18 A | 7.58 B | <0.0001*** |
| Height of Bar | 5.47 | 5.75 | 0.2068 |
| Dark | 6.87 B | 7.79 A | <0.0001*** |
| Depth of indentation | 5.43 B | 7.39 A | <0.0001*** |
| Rounded | 8.00 A | 5.69 B | <0.0001*** |

*Attribute significant at the 95% confidence limit
**Attribute significant at the 99% confidence limit
***Attribute significant at the 99.9% confidence limit

As shown in Table 2 and FIG. 4, the inventive confection has 3 visual attributes that are enhanced relative to the comparative confection. That is, the inventive confection looks significantly more rounded, smooth and has an appearance that led the assessors to conclude that it would be more comfortable in the mouth than the comparative confection.

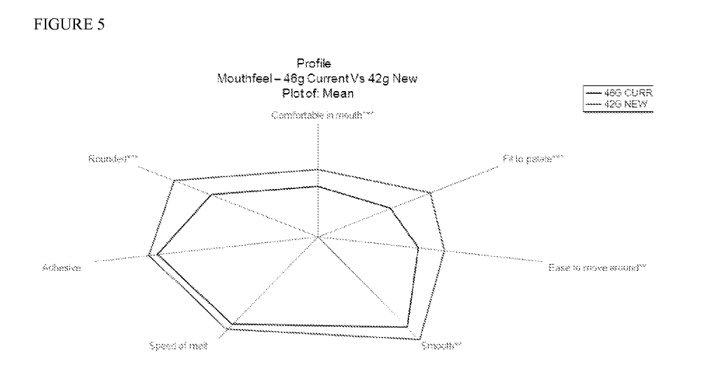

The results of the mouthfeel attribute testing are shown in Tables 3-5, below, and further illustrated by FIG. 5-7.

TABLE 3
Mouthfeel Attribute Testing - Bar Samples

| | Sample | | |
|---|---|---|---|
| | Inventive | Comparative | |
| Attribute | (42 g New) | (46 g Current) | Significance (α) |
| Comfortable in mouth | 5.97 A | 4.42 B | <0.0001*** |
| Fit to palate | 6.24 A | 4.01 B | <0.0001*** |
| Ease to move in mouth | 5.65 A | 4.48 B | 0.0026** |
| Smooth | 10.19 A | 8.93 B | 0.0016** |
| Speed of melt | 9.16 | 8.64 | 0.1491 |
| Adhesive | 7.52 | 7.19 | 0.3219 |
| Rounded | 7.98 A | 5.92 B | <0.0001*** |

*Attribute significant at the 95% confidence limit
**Attribute significant at the 99% confidence limit
***Attribute significant at the 99.9% confidence limit

As shown in Table 3 and FIG. 5, the inventive confection has 5 mouthfeel attributes that are enhanced, in a statistically significant amount, relative to the comparative confection. That is, the inventive confection feels significantly more rounded, more comfortable in the mouth, more easily moved within the mouth and more smooth than the comparative confection. The inventive confection also was rated a better fit to the palate than the comparative confection.

TABLE 4
Mouthfeel Attribute Testing - Block Samples

| | Sample | | |
|---|---|---|---|
| | Inventive | Comparative | |
| Attribute | (114 g New) | (114 g Current) | Significance (α) |
| Comfortable in mouth | 9.21 | 8.68 | 0.1211 |
| Fit to palate | 9.26 | 8.64 | 0.0936 |
| Ease to move in mouth | 9.47 | 9.00 | 0.1562 |
| Smooth | 10.23 | 9.86 | 0.3291 |
| Speed of melt | 9.69 | 9.44 | 0.4554 |
| Adhesive | 7.36 | 7.21 | 0.7007 |
| Rounded | 7.81 | 7.15 | 0.0624 |

*Attribute significant at the 95% confidence limit
**Attribute significant at the 99% confidence limit
***Attribute significant at the 99.9% confidence limit

TABLE 5
Mouthfeel Attribute Comparative Testing—Block Samples

Sample

| | Inventive | Comparative |
|---|---|---|
| Attribute | (114 g New) | (114 g Current) |
| Comfortable in mouth*** | 0.45 | −0.33 |
| Fit to palate*** | 0.45 | −0.38 |
| Ease to move in mouth** | 0.33 | −0.28 |
| Smooth*** | 0.68 | −0.03 |
| Speed of melt^{ns} | 0.23 | −0.05 |
| Adhesive* | 0.57 | 0.10 |
| Rounded*** | 0.60 | −0.30 |

ns Not significant 5%
*Significant at 5%
**Significant at 1*
***Significant at 0.1%

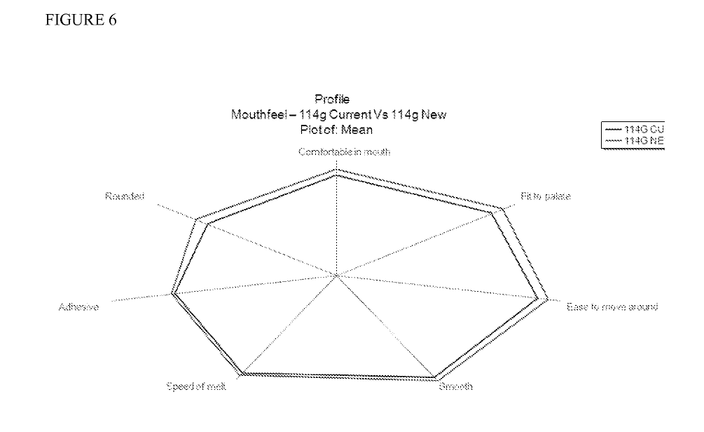

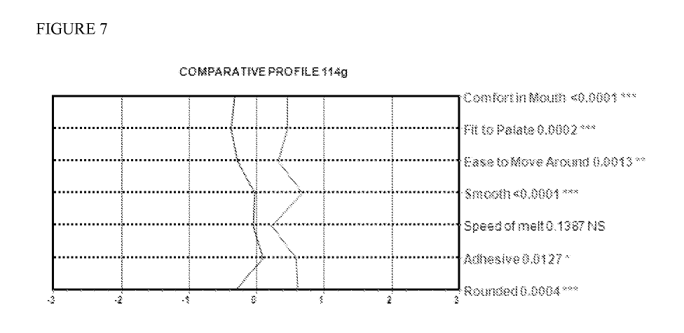

As shown in Tables 4 and 5, and further illustrated by FIG. 6 and FIG. 7, although monadic testing of block inventive samples did not show statistically significant differences in the measured mouthfeel attributes, FIG. 6 nonetheless makes clear that enhancements were perceived by the assessors in the inventive confection as compared to the comparative confection in each of the seven attributes assessed. Further, additional comparative testing was conducted on these samples, and the results shown in Tables 5 and FIG. 7 which confirm that the inventive confection was perceived as enhanced in six of the seven attributes as compared to the comparative confection.

1. A confection having a single arcuate ridge, wherein the ridge extends substantially the entire length of a single piece of the confection.

2. The confection of claim 1, wherein the ridge defines two regions of the confectionery, and at least one of these comprises at least one feature.

3. The confection of claim 2, wherein the both regions defined by the ridge comprise a feature.

4. The confection of claim 3, wherein the features are the same.

5. The confection of claim 3, wherein the features are different.

6. The confection of claim 2, wherein the features comprise depressions, domes, flats, gaps, gorges, hills, hollows, knobs, knolls, peaks, pinnacles, pits, plateaus, points, rises, slopes, valleys, or a combination of these.

7. The confection of claim 6, wherein the features comprise depressions, hollows, knobs, knolls, rises and/or slopes.

8. The confection of claim 7, wherein the features comprise a depression and a rise.

9. The confection of claim 1, wherein the confection has at least one sensory attribute that is enhanced relative to a confection having the same composition and not comprising the ridge.

10. The confection of claim 9, wherein the confection has at least one sensory attribute that is enhanced relative to a confection having the same composition and not comprising the ridge or the feature(s).

11. The confection of claim 10, wherein the sensory attribute that is enhanced is a visual, taste, texture and/or auditory attribute.

12. The confection of claim 11, wherein a visual attribute is enhanced, and the visual attribute comprises expected comfort in mouth, smoothness, height/thickness, darkness, depth of any indentations, roundedness, or a combination of any number of these

13. The confection of claim 11, wherein a taste or texture attribute is enhanced and comprises comfort in mouth, fit to palate, ease of movement in mouth, smoothness, speed of melt, adhesive, roundness, or a combination of any number of these.

14. The confection of claim 11, wherein an auditory attribute is enhanced and comprises a snap, a bite, a chomp, and combinations thereof.

15. The confection of claim 1, comprising a solid confection, a filled confection, or a multi-region confection.

16. The confection of claim 15, wherein the confection comprises chocolate, caramel, taffy, toffee or a combination of these.

17. The confection of claim 1, provided as an individual piece.

18. The confection of claim 1, provided in the form of a multi-piece stick, bar or block.

19. A confection having a base, four sidewalls and a top, wherein the top of an individual piece of the confection comprises a single arcuate ridge, wherein the ridge extends substantially the entire length of the individual piece.
